(19) United States
(12) Patent Application Publication
(10) Pub. No.: US 2018/0117879 A1
(43) Pub. Date: May 3, 2018

(54) MULTILAYER AUTOMOTIVE COMPONENT

(71) Applicant: Benteler Automobiltechnik GmbH, Paderborn (DE)

(72) Inventors: Georg FROST, Steinheim (DE); Markus KETTLER, Paderborn (DE)

(21) Appl. No.: 15/795,692

(22) Filed: Oct. 27, 2017

(30) Foreign Application Priority Data
Oct. 27, 2016 (DE) 10 2016 120 567.2

(51) Int. Cl. B32B 15/01; B32B 3/26; C22C 38/18; C22C 38/06; C22C 38/04; C22C 38/02; C22C 38/00; B62D 25/04; B62D 29/00; B62D 21/15

(52) U.S. Cl. CPC B32B 15/011; B32B 3/263; C22C 38/18; C22C 38/06; C22C 38/04; B32B 2605/00; C22C 38/002; B62D 25/04; B62D 29/007; B62D 21/157; C22C 38/02

(57) ABSTRACT

An automotive component is disclosed having at least two layers, a middle layer of a hardened steel material and an outer layer of a stainless steel alloy, at least two regions having mutually different wall thicknesses. The atomic hydrogen content in the middle layer one hour after completion of press-hardening is less than 0.5 ppm.

### RELATED APPLICATIONS

The present application claims the priority of German Application Number 10 2016 120 567.2, filed Oct. 27, 2016, the disclosure of which is hereby incorporated by reference herein in its entirety.

### BACKGROUND

### 1. Field of the Invention

The disclosure is related to a vehicle component and, more specifically, a vehicle component manufactured by hot-forming and press-hardening.

### 2. Description of the Related Art

It is known, from the prior art, to produce automotive components by working sheet metal. In the context of automotive components produced from a steel alloy, use is made in particular of hot-working and press-hardening technology. In this context, a blank made of a hardenable steel alloy is first heated to above the AC3 temperature. The AC3 temperature is also referred to as the austenizing temperature. The steel sheet blank heated in this manner is then worked in the hot state and subsequent to working is cooled rapidly such that the material microstructure is hardened. This procedure is also referred to as press hardening.

The drawback with hardened automotive components produced in this manner is that they are susceptible to corrosion. There is therefore a need for subsequent corrosion protection treatment.

It is therefore also known, from the prior art, to use materials that are already pre-coated. To that end, the blanks that are to be hot-worked and press-hardened have a corrosion protection layer. This is either already alloyed to the steel material prior to hot-working, or can also be alloyed during the hot-working process. Corrosion protection coatings of this kind are generally based on an aluminum-zinc alloy or an aluminum-silicon alloy.

The drawback of this is that hydrogen that is present in the steel and/or hydrogen that is introduced into the steel material during austenization is bound by the above-described corrosion protection coating, in particular after completion of the press-hardening procedure. During processing of the finished automotive component, in particular when welding on other automotive components, it is possible for cracks to form, which can have a negative effect on the required crash properties in the event of an automotive accident. This drawback, referred to as hydrogen embrittlement, is also termed delayed fracturing.

In order to avoid this problem, one strategy is to attempt, by elaborate technical measures already during heating, to minimize the hydrogen content in the steel material. For example, in a heating furnace, a furnace interior atmosphere is set in a targeted manner with a low hydrogen content and/or a shielding gas that binds hydrogen. It is also known to perform surface decarburization.

In the case of components having mutually differing wall thicknesses, in particular those produced by partial rolling of the starting material, the above-described effect of elevated undesired hydrogen content in the highly rolled regions in the steel material is even greater.

### SUMMARY

It is therefore an object of the disclosure to manufacture an automotive component which overcomes the described drawbacks and in particular the production of which does not require elaborate processing or post-treatment.

In one exemplary embodiment, the automotive component is produced by hot-working and press-hardening and has at least two layers. A middle layer is made of a hardened steel alloy. For this purpose, use can be made in particular of a boron-manganese steel, for example 22MnB5. An outer layer, joined to the middle layer, is moreover preferably made of a stainless steel alloy. Preferably, two outer layers are made which enclose the middle layer. In particular, the layers are joined to one another in a material-bonded manner over their entire surface. Furthermore, the automotive component has at least two regions having mutually different wall thicknesses. This means that the wall thickness of one region of the automotive component is different to that of another region. According to the invention, the atomic hydrogen content in the middle layer one hour after completion of the press-hardening procedure is less than 0.5 ppm. In that context, the label ppm means parts per million and relates to a respective volume in question.

The steel material is in particular a multilayer steel. This is produced for example by roll-bonded cladding. Then, a strip or a blank of the multilayer steel is partially rolled further. Preferably, the strip is hot-rolled, then partially cold-rolled so as to set mutually different wall thicknesses, and then cut into blanks. The advantage that is essential to the invention is now that the hydrogen fraction or hydrogen content in the middle layer is extremely low. This is due on one hand to the fact that there is no inclusion of hydrogen during the roll-bonded cladding of the outer layers onto the middle layer. Also, no hydrogen that might be present in the outer layer passes into the middle layer. Should a fraction of hydrogen nonetheless be present in the starting material of the hardenable steel alloy of the middle layer, this can still diffuse out, after completion of the press-hardening procedure, through the outer layer made of the stainless steel alloy. Thus, the invention avoids delayed fracturing, in particular in the middle layer. This makes it possible to avoid onerous process measures for conducting the heating, in particular for controlling a furnace interior atmosphere. In particular, more efficient heating methods may take place, for example induction, contact heating or else thermal radiation. It is also possible to dispense with onerous post-treatment, for example surface decarburization. Any residual fraction of hydrogen that might be present can diffuse out through the outer layer, such that the fraction of hydrogen in the middle layer, at least one hour after the end of the press-hardening procedure, or even days, weeks or months after production, is less than 0.5 ppm.

In the event of a larger fraction of hydrogen being present in the middle layer, this will diffuse out during the heating and hot-working procedure. In exemplary embodiment, the automotive component has three layers, the middle layer being made of the hardened steel alloy and the respective outer layer being made of a stainless steel alloy. The stainless steel alloy is in particular a ferritic steel alloy, in particular a high-grade steel alloy. The stainless steel alloy can also be referred to as a rust-resistant steel alloy.

According one exemplary embodiment, the outer layers and the middle layer are connected in a material-bonded manner over their entire surface, such that there are essentially no inclusions or impurities between the layers, in particular a metallurgic bond being formed. According to the invention, the individual layers are preferably connected over their entire surface in a material-bonded and metallurgic manner. The starting material used for the invention can for example be created by hot-rolling three previously mechanically and/or materially pre-joined slabs, or by using a slab cast in multiple stages, or a deposition-welded slab.

An alloy having, in addition to iron and the impurities arising from ore melting, the following alloying constituents in percent by weight:

| | |
|---|---|
| carbon (C): | 0.080% to 0.160% |
| silicon (Si): | 0.50% to 1.80% |
| manganese (Mn): | 0.80% to 1.40% |
| chromium (Cr): | 13.00% to 22.00% |
| aluminum (Al): | 0.50% to 1.50% |
| phosphorus (P): | maximum 0.060% |
| sulfur (S): | maximum 0.020% |

These constituents have proven to be particularly advantageous when used as the ferritic stainless steel alloy.

While chromium ensures heat resistance and thus a scale-free surface during heating and hot-working, the temperable steel alloy of the middle layer ensures maximum possible tensile strength. Reference is also made here, with regard to other ferritic stainless steel alloys that might be used, to the content of EN 10088-1, with chromium contents between 10.5 and 30% depending on the type. Stabilizing additions of less than 0.5% of titanium, niobium or zirconium serve to ensure weldability, as does the carbon content which is limited to 0.16%.

In particular as a three-layer sheet metal composite, the automotive component has a total thickness, wherein the thickness of an outer layer is at least 3% and at most 15%, preferably 4% to 10%, of the total thickness. The total thickness is preferably between 1 and 10 mm, in particular between 1.7 and 3.5 mm. The middle layer then represents the remainder of the total thickness. Accordingly, a thinner total thickness is to be observed in regions with a thinner wall thickness than this. However, the percentage contribution of the outer layers to this thinner total thickness can be approximately the same as stated above.

In particular, the fraction of atomic hydrogen in the middle layer, but also in the outer layers in the region of thinner wall thickness, is less than 0.5 ppm. The automotive component is in particular produced from a flexibly rolled blank or a flexibly rolled strip that is cut into blanks. The region of thinner wall thickness has, in particular, a wall thickness that is less than 0.9 times, in particular 0.8 times, preferably 0.7 times and especially preferably less than 0.6 times the wall thickness of the region of greater wall thickness.

In particular, the automotive component has a tensile strength Rm of greater than 1450 MPa. Partially different strengths can be observed in the finished automotive component, in particular as a consequence of the mutually different wall thicknesses.

The wall thickness is in each case made up of the thickness of the outer layer, the thickness of the middle layer and optionally the thickness of the other outer layer.

The wall thickness is preferably between 1 and 10 mm, in particular between 1.7 and 3.5 mm. In terms of percentage, the thickness of the outer layer is 3% to 15%, preferably 4% to 10%, of the wall thickness. The remaining wall thickness fraction is then formed by the middle layer. The wall thickness is less in the region of thinner wall thickness than in the region of greater wall thickness. However, the distribution, in terms of percentage, of the outer layer and the middle layer is similar.

### BRIEF DESCRIPTION OF THE DRAWINGS

For an understanding of embodiments of the disclosure, reference is now made to the following description taken in conjunction with the accompanying drawings, in which:

FIG. 1 is a plan view of an automotive component in the form of a B-pillar; and,

FIG. 2 is a sectional view taken along II-II of the automotive pillar of FIG. 1.

In the figures, the same reference signs are used for identical or similar components, even if a repeated description is omitted for reasons of simplicity.

### DETAILED DESCRIPTION OF SOME EMBODIMENTS

Some embodiments will now be described with reference to the Figures.

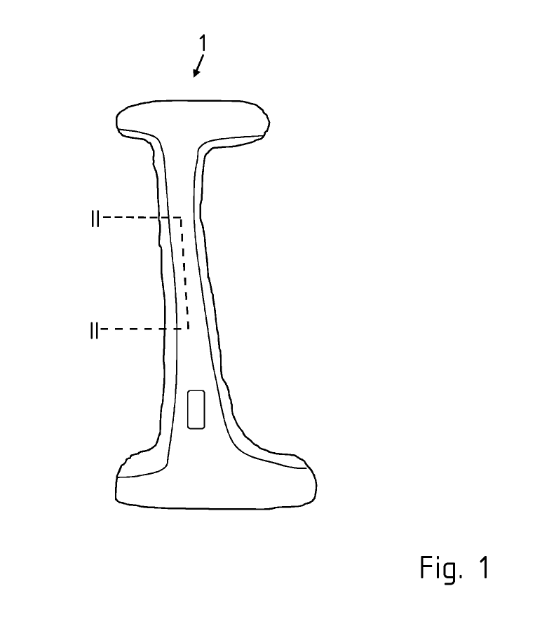

Referring to FIG. 1, an automotive component 1 in the form of a B-pillar for the lateral structure of a motor vehicle is illustrated. The B-pillar can be used between door sills and the roof frame, and primarily serves for the overall stability of the vehicle body, and for collision energy dissipation and intrusion protection in the event of a side impact.

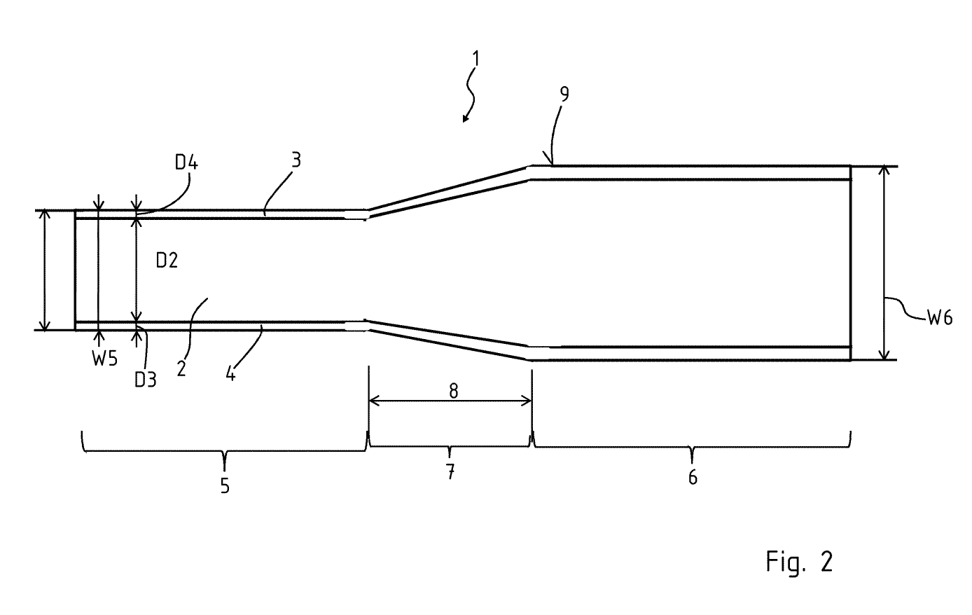

Referring to FIG. 2, a layered construction or multilayer steel taken along the line II-II in FIG. 1 is illustrated.

The longitudinal sectional view illustrates that the automotive component 1 is of three-layer construction. In this context, a middle layer 2 is enclosed between two outer layers 3, 4. The outer layers 3, 4 are each of essentially the same thickness. It is also conceivable for an outer layer 3 to have a greater thickness D3 than the other outer layer 4, or vice versa. Further, the automotive component 1 has two regions. A first region 5 has a wall thickness W5 that is less than the wall thickness W6 of the second region 6. A transition region 7 extends between the two regions 5, 6. The breadth 8 of the transition region 7 is preferably between 20 and 250 mm, in particular between 50 and 200 mm. The layers 2, 3, 4 are continuous. In that context, the middle layer 2 has a thickness D2 that preferably makes up between 70% and 97% of the respective wall thickness. The thickness D3, D4 of the outer layers 3, 4 is respectively preferably between 3 and 15%, in particular between 4% and 10% of the respective wall thickness. In the second region 6 of greater wall thickness W6, the distribution, in terms of percentage, of the thicknesses D3, D4 of the outer layers 3, 4 and of the middle layer 2 is identical.

It is also conceivable for the transition region 7—and the associated increase in thickness—to be formed only on a first side 9. Therefore, the opposite second side 10 is flat, or planar, in the region of the thickness increase.

The automotive component 1 can have other regions. These can have the wall thickness W5 of the first region 5 or the wall thickness W6 of the second region 6, or wall thicknesses that are different therefrom, either greater or smaller.

According to one exemplary embodiment, any sheet metal component used on a motor vehicle can be produced as the automotive component 1. In particular, these are automotive structural components, body components, but also sheet metal outer skin components or the like. For example, door sills, pillars, tunnel, transverse or longitudinal beams, floor sheets, battery trays, crash boxes, firewalls, rails and supports can be manufactured in accordance with the disclosure.

The automotive component 1 is coupled to a further component by material-bonded joining, for example welding. A weld spot or a weld seam then preferably passes through the outer layer 3 and connects the other component in a material-bonded manner to the middle layer 2. By virtue of the low hydrogen content in the middle layer 2, this does not cause crack formation or the like.

The foregoing description of some embodiments of the invention has been presented for purposes of illustration and description. It is not intended to be exhaustive or to limit the invention to the precise form disclosed, and modifications and variations are possible in light of the above teachings or may be acquired from practice of the invention. The specifically described embodiments explain the principles and practical applications to enable one ordinarily skilled in the art to utilize various embodiments and with various modifications as are suited to the particular use contemplated. It is intended that the scope of the invention be defined by the claims appended hereto, and their equivalents. Further, it should be understood that various changes, substitutions and alterations can be made hereto without departing from the spirit and scope of the invention as described by the appended claims.

1. An automotive component, comprising:
at least two layers, a middle layer of a hardened steel material and an outer layer of a stainless steel alloy,
the automotive component comprises at least two regions having mutually different wall thicknesses,
wherein the atomic hydrogen content in the middle layer one hour after completion of press-hardening is less than 0.5 ppm.

2. The automotive component of claim 1, wherein the at least two layers comprises three layers, wherein the middle layer is made of a hardened steel alloy and the respective outer layer is made of a stainless steel alloy.

3. The automotive component of claim 1, wherein the stainless steel alloy is a ferritic steel alloy.

4. The automotive component of claim 1, wherein the stainless steel alloy is a high-grade steel alloy.

5. The automotive component of claim 1, wherein the automotive component has a tensile strength Rm of greater than 1450 MPa.

6. The automotive component of claim 5, wherein the proportion of atomic hydrogen in the region of thinner wall thickness is less than 0.5 ppm.

7. The automotive component of claim 1, wherein the automotive component is produced from a flexibly rolled blank or a flexibly rolled strip that is cut into blanks.

8. The automotive component of claim 1, wherein the wall thickness (W5) in the region of thinner wall thickness (W5) is less than 0.9 times the wall thickness (W6) of the region of thicker wall thickness (W6).

9. The automotive component of claim 1, wherein the wall thickness (W5) in the region of thinner wall thickness (W5) is less than 0.8 times the wall thickness (W6) of the region of thicker wall thickness (W6).

10. The automotive component of claim 1, wherein the wall thickness (W5) in the region of thinner wall thickness (W5) is less than 0.7 times the wall thickness (W6) of the region of thicker wall thickness (W6).

11. The automotive component of claim 1, wherein the wall thickness (W5) in the region of thinner wall thickness (W5) is less than 0.6 times the wall thickness (W6) of the region of thicker wall thickness (W6).

12. The automotive component of claim 1, wherein the individual layers are arealy joined to one another in a material-bonded manner.

13. The automotive component of claim 1, wherein the component is produced by hot-working and press-hardening.
